(19) United States
(12) Patent Application Publication
(10) Pub. No.: US 2002/0107847 A1
(43) Pub. Date: Aug. 8, 2002

(54) Method and system for visual internet search engine

(76) Inventor: Carl E. Johnson, Rancho Santa Margarita, CA (US)

Correspondence Address: CHRISTIE, PARKER & HALE, LLP, P.O. BOX 7068, PASADENA, CA, 91109-7068, US

(21) Appl. No.: 09/975,755

(22) Filed: Oct. 10, 2001

Related U.S. Application Data
(60) Provisional application No. 60/239,146, filed on Oct. 10, 2000.

(51) Int. Cl. G06F 7/00

(52) U.S. Cl. 707/3

(57) ABSTRACT

A system and method for generating visual or multimedia search results in response to an Internet document search query. HTML documents are retrieved from the Internet and keywords are extracted from the HTML documents based on the structure of the HTML documents and the HTML documents' metatags. The HTML documents are scanned for representative non-textual content such as images or audio files. The HTML documents' locations, extracted keywords, and representative non-textual content are stored in data records in a database for future use. The database is used to create a search result HTML document containing the representative non-textual content.

### CROSS REFERENCE TO RELATED APPLICATIONS

This application claims the benefit of U.S. Provisional Application No. 60/239,146, filed Oct. 10, 2000 and entitled “METHOD AND SYSTEM FOR VISUAL INTERNET SEARCH ENGINE” the contents of which are hereby incorporated by reference as if set forth in full herein.

### BACKGROUND OF THE INVENTION

The present invention relates to networked computer systems in general and computer systems for displaying results of information found using search engines in particular.

The Internet is a global network of computers. There are more than 200 million computers linked in the Internet, and this number is increasing daily. These computers function as clients and/or servers. A broad class of clients can be defined as Web browsers hosted by devices such as personal computers to display information from the Internet. Servers can be defined as software programs running on computers that make information available to Web browsers on the Internet. The network of clients and servers supplying information over the Internet is often called the World Wide Web (Web). Information stored within the Web is typically stored in formatted documents written in Hyper Text Mark-up Language (HTML). These HTML documents may also reference files containing audiovisual information such as images, sounds, animations, or videos to be displayed in the HTML document. There can also be links (hyperlinks) to other HTML documents on the Web. A group of HTML documents organized around some central theme and served from a single server is commonly termed a “Web site”. Each HTML document is stored at a specific “address” on the Internet. For example, below is the address to a document at the White House:

47471/FLC/M788
http://www.whitehouse.gov/WH/EOP/html/principals.html
a b c d e f

The format for such addresses is as follows:

| | |
|---|---|
| a-http:// | Hyper Text Transport Protocol |
| b-www | World Wide Web |
| c-whitehouse | The “Domain” or entity you are looking for. |
| d-.gov | This is a Government site. Other types |
| | include .com for company, .org for |
| | organization. A Company can call itself |
| | .com, .net, or .org. |
| e-/WH/EOP/html/ | The “Path” to the document. This can be |
| | thought of as the directory structure on |
| | your hard disk. |
| f-principals.html | This is the name of the document. The |
| | “.html” indicates it is an html document. |

The address is formally known as the Uniform Resource Locator (URL) of the HTML document.

URLs are used by Web browsers to retrieve the HTML documents. The user can type the complete address of the HTML document they are looking for into text field at the top of their Web browser and the Web browser will retrieve a HTML document from the address and generate a display based on the formatting instructions within the HTML document. The user can then select a hyperlink embedded in the display to instruct the Web browser to retrieve another document.

The huge number of Web sites comprising the Web has prompted the development of specialized Web sites containing databases of Web sites organized by searchable keywords. These specialized Web sites are known as “search engines”. A search engine can be thought of as a store directory for the Internet. Just as it is impractical to visit a large shopping mall and find a specific item by going from unknown store to unknown store, it may be impossible to find information on the Internet without a directory. Search engines use software programs called “spiders” and “indexers” to index Web sites. These Web site indexes usually contain the title and description of the indexed Web pages contained within the indexed Web sites. Users go to these search engines and type in a word, phrase, or a question. The search engine generates a database query based on the word, phrase, or question and queries its database of Web sites and returns to the user a list of Web sites that contain the word, phrase, or possibly the answer to the question.

Current search engines return only the textual equivalent of their indexed Web sites; however, most Web sites are composed of a rich mixture of graphics, animations, video, and auditory content as well as textual information. Web site designers use this rich mixture of media types to efficiently convey the nature and purpose of the Web site. Search engines based on textual descriptions only capture the textual component of the Web site. This textual component, while it may accurately reflect the nature of the Web site, is more difficult for users to scan quickly than representations of Web sites that take full advantage of the rich media types used in Web site design.

Therefore, it would be advantageous to develop a search engine capable of returning a graphical and/or auditory representation of indexed Web sites.

### SUMMARY OF THE INVENTION

The present invention provides a method and system to retrieve a HTML document from the Internet and extract keywords from the HTML document based on the structure of the HTML document and the HTML document's metatags. The HTML document is scanned for representative non-textual content such as images, video, animation, audio, java applets, or any other multimedia objects files. The HTML document location, extracted keywords, and representative non-textual content are stored in data records in a database for future use. When a search query is received containing keywords, data records containing the keywords are retrieved from the database. A search result HTML document is created using the HTML document location and representative non-textual content stored in the retrieved data records. The created search result HTML document may the contain representative graphical images and other non-textual content taken from the HTML document as well as textual information extracted from the HTML document. The search result HTML document is sent as the response to the search query. The search result HTML document may then be displayed by a Web browser so that a user sees and/or hears a non-textual as well as a textual representation of the HTML document.

### BRIEF DESCRIPTION OF THE DRAWINGS

These and other features, aspects, and advantages of the present invention will become better understood by referring to the following description and accompanying drawings where:

FIG. 1 is an object diagram of Web servers, a Web browser, and an exemplary search engine built according to the current invention communicating over the Internet;

FIG. 2 is a deployment diagram of an exemplary deployment of the software objects of FIG. 1;

FIG. 3 is a hardware architecture diagram for an exemplary general purpose computer capable of hosting an exemplary search engine according to the current invention;

FIG. 4 is a sequence diagram of an exemplary Web spider collecting URLs for use by an exemplary indexer;

FIG. 5 is a diagram of an exemplary database record created by the Web spider of FIG. 4;

FIG. 6 is a sequence diagram of the operations of an exemplary indexer while indexing a Web site;

FIG. 7 is a procedural diagram of an exemplary indexing process for indexing a Web site according to the present invention;

FIG. 8 is a diagram of exemplary data records created in an exemplary database by the indexing process of FIG. 7;

FIG. 9 is a sequence diagram of an exemplary communications sequence between an exemplary Web browser and a search engine according to the present invention; and

FIG. 10 is an exemplary results page according to the present invention.

### DETAILED DESCRIPTION OF THE INVENTION

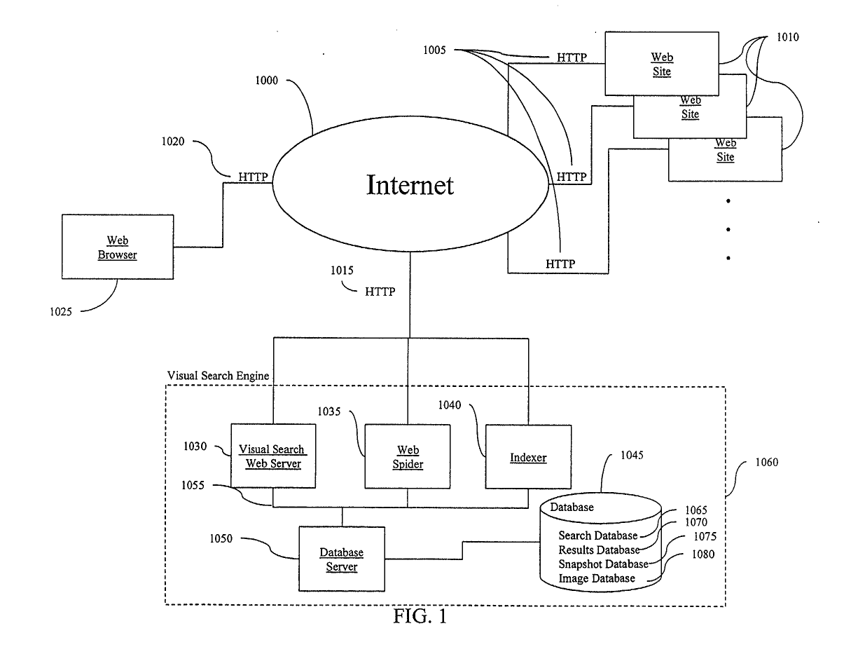

FIG. 1 is an object diagram of Web servers and a Web browser coupled via a communications network to an exemplary search engine built according to the current invention. Web browser 1025 is coupled to Internet 1000 over Web browser communications link 1020. The Web browser communications link is implemented using the Hyper Text Transfer Protocol (HTTP) on top of the Transmission Control Protocol/Internet Protocol (TCP/IP) suite of communications protocols. A plurality of Web sites 1010 are also coupled to the Internet via a plurality of HTTP based Web site communications links 1005. The Web sites supply HTML documents at the request of the Web browser and the Web browser displays the HTML documents.

Web spider 1035 communicates to other objects on the Internet via visual search engine communications link 1015. The visual search engine communications link is implemented using the HTTP communications protocol. The Web spider 1035 visits each of the plurality of Web sites and collects keywords from each linked HTML document within a Web site. The keywords may come from the HTML documents' titles, “keyword” or “description” Meta tags, or from the body of the HTML documents themselves. The Web spider builds search database 1065 of visited Web sites and keywords using database server 1050. The database server is coupled to database 1045 for storage and retrieval of search results.

Indexer 1040 communicates to other objects on the Internet via the visual search engine communications link. The indexer uses the search database of visited Web sites and keywords to collect detailed information about the Web sites visited by the Web spider. The detailed information is stored by the Indexer in results database 1070, snapshot database 1075, and image database 1080, all of which may be supported by the database server.

Visual search Web server 1030 communicates to other objects on the Internet via the visual search engine communications link. The visual search Web server responds to queries from the Web browser for Web sites containing search keywords as specified by a user using the Web browser. The visual search Web server constructs results documents using the information stored by the indexer in the results database, the snapshot database, and the image database. The visual search Web server uses the services of the database server to retrieve data from the results database, the snapshot database, and the image database.

The combination of the visual search Web server, the Web spider, the indexer, the database server, and the database comprise visual search engine 1060.

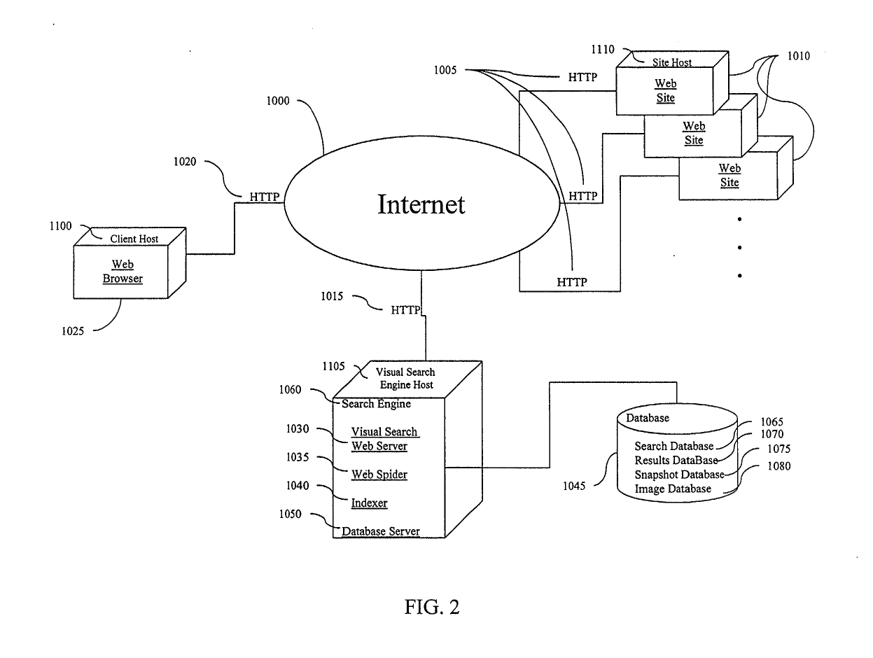

FIG. 2 is a deployment diagram of an exemplary deployment of the software objects of FIG. 1. Client host 1100 hosts Web browser 1025. Client host 1100 is coupled via Web browser communications link 1020 to Internet 1000. Each of the plurality of Web sites 1010 may have their own site host as exemplified by site host 1110. A site host couples a Web site to the Internet via a HTTP communications link as exemplified by the plurality of Web site communications links 1005. Visual search engine host 1105 hosts visual search Web server 1030, Web spider 1035, indexer 1040, and database server 1050. The visual search engine host is coupled to database storage device 1045 for storage of search database 1065, results database 1070, snapshot database 1075, and image database 1080. The visual search engine host couples its hosted software objects to the Internet via visual search engine HTTP communications link 1015.

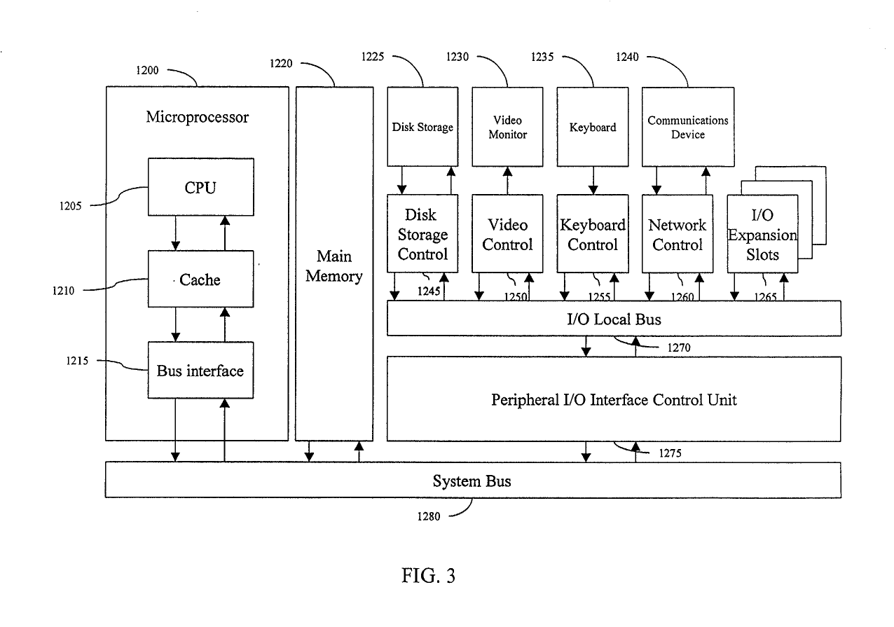

FIG. 3 is a diagram of an exemplary architecture for a general purpose computer capable of serving as a host for visual search engine 1060 (FIG. 2) software components. Microprocessor 1200, comprised of a Central Processing Unit (CPU) 1205, memory cache 1210, and bus interface 1215, is coupled via system bus 1280 to main memory 1220 and I/O control unit 1275. The I/O interface control unit is coupled via I/O local bus 1270 to disk storage controller 1245, video controller 1250, keyboard controller 1255, network controller 1260, and Input Output (I/O) expansion slots 1265. The disk storage controller is coupled to disk storage device 1225. The video controller is coupled to video monitor 1230. The keyboard controller is coupled to keyboard 1235. The network controller is coupled to communications device 1240.

Computer program instructions implementing visual search engine 1060 (FIG. 2) software components are stored on the disk storage device until the microprocessor retrieves the computer program instructions and stores them in the main memory. The microprocessor then executes the computer program instructions stored in the main memory to implement the visual search engine software components. The disk storage device is used to as permanent data storage for search database 1065, results database 1070, snapshot database 1075, and image database 1080 (all of FIG. 2). The visual search engine host is coupled to Internet 1000 (FIG. 2) via the communications device.

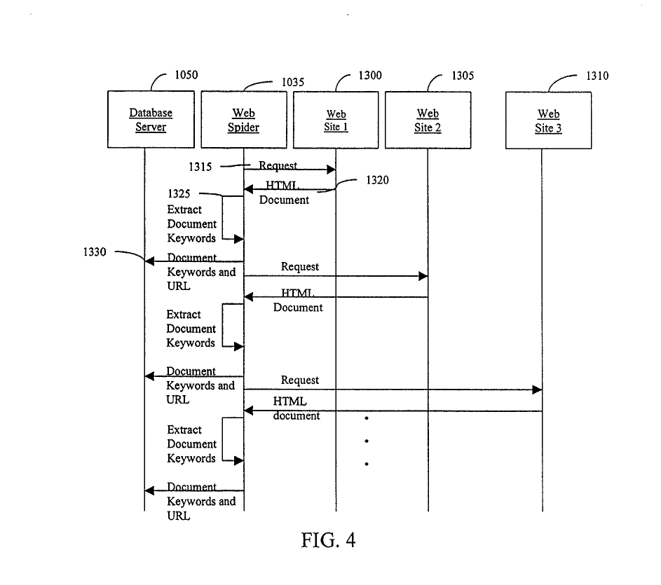

FIG. 4 is a sequence diagram of an exemplary Web spider process. Web spider 1035 sends request 1315 to Web site 1 1300 for an HTML document. Web site 1 sends HTML document 1320 in response to the request. The Web spider extracts keywords from the HTML document 1325. The Web spider may use a variety of textual content within the HTML document as sources for keywords. For example, the Web spider may collect the title of the HTML document as a keyword. Other sources for keywords are the “keyword” or “description” Meta tags, or the body of the HTML documents themselves. The Web spider puts the URL and keywords for each searched page into search database 1065 (FIG. 2) using the services of database server 1050. The process is repeated for as many Web sites as the Web spider can reach given some resource constraint such as time or data storage.

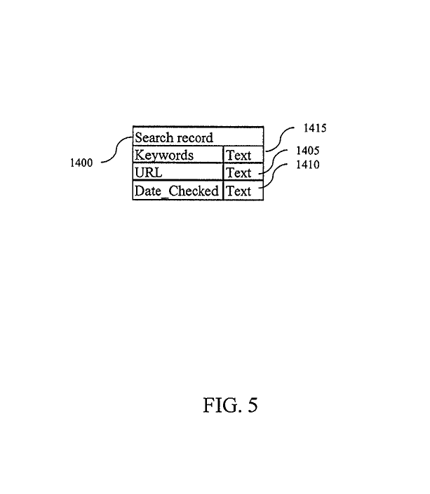

FIG. 5 is a depiction of an exemplary search database record as created by Web spider 1035 from HTML document 1320 and stored by database server 1050 (all of FIG. 4). Search database record 1400 is comprised of three fields. Keywords field 1415 contains all of the keywords extracted from the HTML document by the Web spider. URL field 1405 contains the URL of the HTML document searched by the Web spider. Date checked field 1410 contains the date that the HTML document was searched by the Web spider. A search database record is created for each HTML document searched by the Web spider.

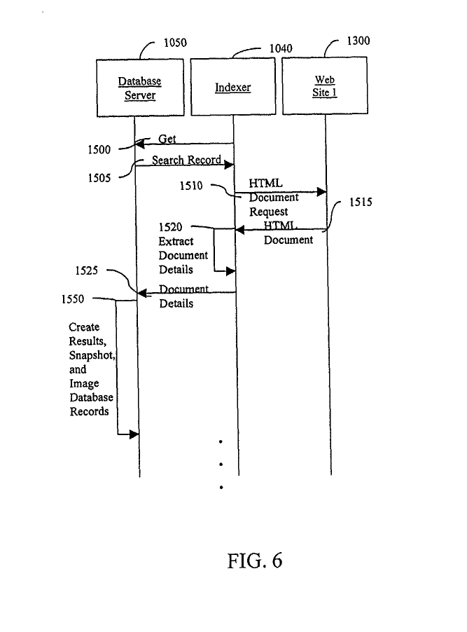

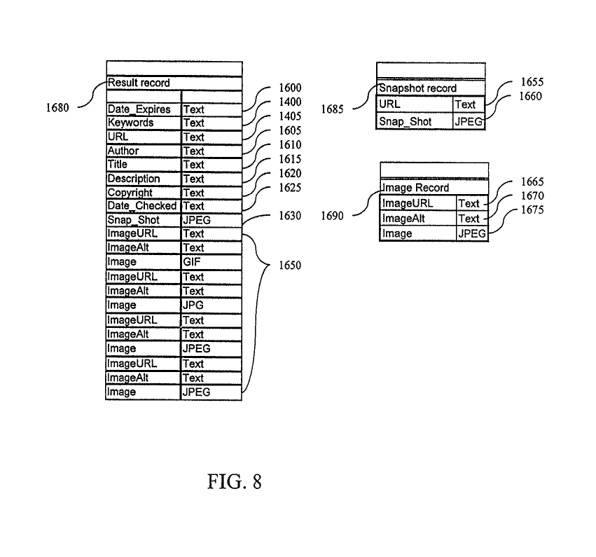

FIG. 6 is a sequence diagram of the process executed by an indexer to collect detailed information from HTML pages as identified by Web spider 1035 (FIG. 4). Indexer 1040 gets 1500 search database record 1505 from database server 1050. The search database record is partially comprised of a URL field containing a URL as depicted in FIG. 5. The indexer uses the URL from the search database record to send HTML document request 1510 to Web site 1 1300. Web site 1 responds by sending HTML document 1515 to the indexer. The indexer extracts document details 1525 from the HTML document at step 1520 in a process to be described. The document details are sent to the database server and the database server creates a results, snapshot, and image database record for the HTML document. The structures of these database records are depicted in FIG. 8. The indexer repeats the process of retrieving a search database record, retrieving a HTML document based on a URL stored in the search database record, extracting document details from the HTML document, and storing the document details in several databases for each Web site searched by Web spider 1035 (FIG. 4).

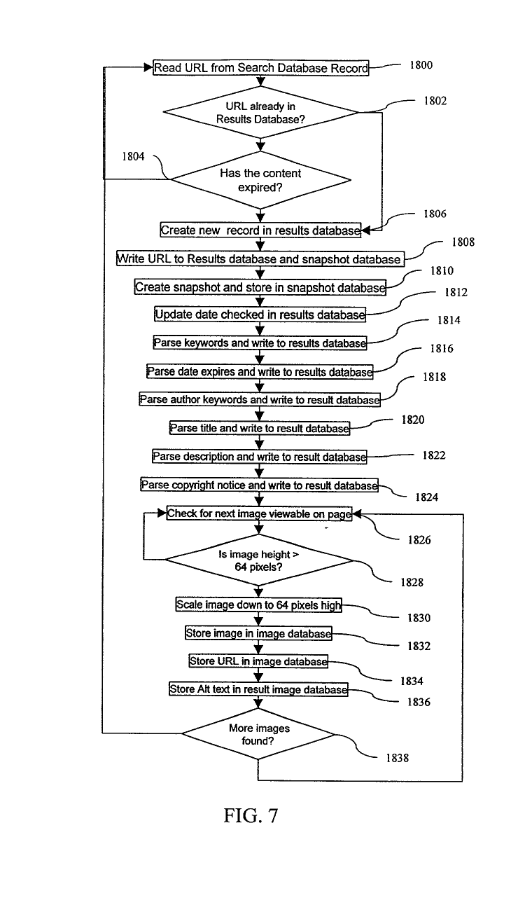

FIG. 7 is a detailed process flow diagram for an exemplary indexing process performed by indexer 1040 (FIG. 6). The indexer reads 1800 a URL from search database record 1505 (FIG. 6). The indexer checks 1802 the URL to see if the indexer has already indexed the HTML document pointed to by the URL. If the HTML document has been previously indexed, the indexer checks 1804 to see if the content of the HTML document has expired. If the document pointed to by the URL has not been indexed or if the content of the HTML document has expired, the indexer creates 1806 a new record in results database 1070 (FIG. 2). The indexer writes 1808 the URL in the results database. The indexer uses the URL to access the HTML document pointed to by the URL and creates 1810 a “snapshot” of the HTML document. The indexer creates a snapshot by creating an internal representation of the screen display as the screen display would be created by a Web browser when interpreting the HTML document. The internal representation is then reduced in size and stored by the indexer in the snapshot database. In the exemplary embodiment, the size of the reduced snapshot is 64 pixels by 64 pixels. This size is small enough to be easily stored yet large enough to be viewed as a recognizable representative image. Alternatively, the size of the snapshot may be changed to take advantage of system display resolutions.

The indexer updates 1812 the date checked field in the results database. The indexer parses 1814 the keywords from the search database record and stores the keywords in the results database. The indexer parses 1816 the date the HTML document will expire from the HTML document's metatags and puts the expiration date in the results database. The indexer parses 1818 any author data found in the HTML document and stores the author data in the results database. The indexer parses 1820 the title of the HTML document from the HTML document and stores the title in the results database. The indexer parses 1822 the description of the HTML document from the HTML document and stores the description in the results database. The indexer parses 1824 the copyright notice in the HTML document from the HTML document and stores the copyright notice in the results database.

The indexer checks 1826 the HTML document to extract images from the HTML document that might be representative of the contents of the HTML document. For example, an advertisement placed in the HTML document would not be considered a representative image of the contents of the HTML document, neither would an image used as a background texture be considered a representative image. Therefore, several tests might be used to determine which of the HTML document's multiple images may be included in image database 1080 (FIG. 2). For example, images may be selected from the HTML document on the basis of the images relative size and position with the assumption that the largest and most prominent images on HTML document give the greatest clue to the true nature and content of the HTML document. An exemplary test for a representative image is shown at process step 1828. Many Web advertisements are GIF, JPEG, or Java applets. They are normally one of the following sizes: 468×60, 125×125, 120×60, 88×31, 400×40, 400×50, 250×72, or 500×72. These defacto standards facilitate placement of dynamically generated advertisements in HTML documents. The standard sizes for advertisement images allow a Web page designer to create a Web page layout knowing that the dynamically generated graphics will always fit within an allotted space. These defacto standards may be exploited to reject advertisement images as representative images as shown in step 1828. In the exemplary embodiment of a representative image selection step, the indexer tests each image in the HTML document to see if the HTML document image is greater than 64 pixels in height. If the HTML document image is greater than 64 pixels in height, the indexer takes the HTML document image as a representative image. If the HTML document image is less than or equal to 64 pixels in height, then the indexer extracts a new image from the HTML document for processing. If the HTML document image is greater than 64 pixels in height, then the indexer scales 1830 the HTML document down in the same manner as the snapshot image at step 1810. The indexer stores 1832 the scaled down HTML document image in the image database. The indexer stores the URL in the image database. Some HTML documents contain “alt text” tags that describe the HTML document images. The indexer stores 1836 any alt text tags it finds in the image database. The indexer continues 1838 extracting images from the HTML document until no more images are found.

FIG. 8 is a depiction of exemplary database records created by indexer 1040 when it indexes a HTML document.

Snapshot database record 1685 contains two fields. URL field 1655 contains the URL of an indexed HTML document. Snapshot field 1660 contains a scaled down image of the HTML document as displayed by a Web browser.

Image database record 1690 contains three fields. Image field 1675 contains a scaled down HTML document image extracted from a HTML document. ImageURL field 1665 contains the URL of the HTML document from which the scaled down HTML document image was extracted. ImageAlt field 1670 contains text extracted from any alt text tag corresponding to the scaled down HTML document image.

Results database record 1680 is comprised of 21 fields. Date expires field 1600 contains the date when the contents of an indexed HTML document expires. Keywords field 1400 contains keywords extracted from the indexed HTML document. URL field 1405 contains the URL of the indexed HTML document. Author field 1605 contains any authorship data extracted from the indexed HTML document. Title field 1610 contains the title of the indexed HTML document. Description field 1615 contains a description of the indexed HTML document. Copyright field 1620 contains any copyright notice found the in the indexed HTML document. Date checked field 1625 contains the date the HTML document was indexed. Snapshot field 1630 may contain a pointer to a snapshot data record for the indexed HTML document. Alternatively, the snapshot field may contain a snapshot created from the HTML document. Image data fields 1650 may contain scaled down representative images extracted from the indexed HTML document, scaled down representative image URLs, and any alt text data associated with the scaled down representative images. Alternatively, the Image data fields may be used for pointers to image database records for the indexed HTML document.

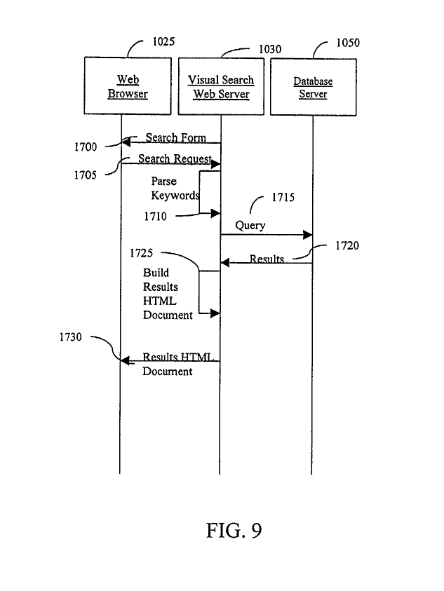

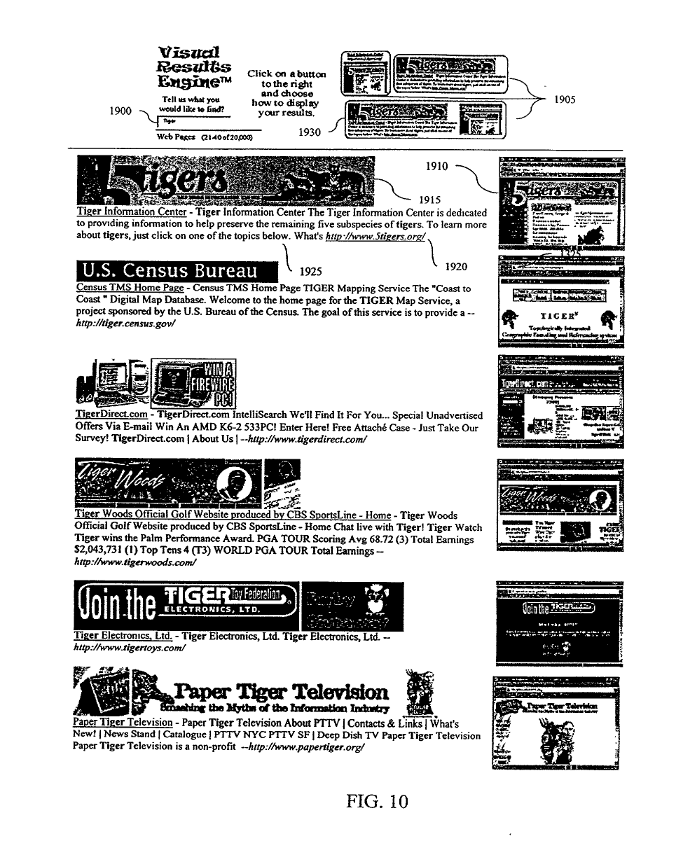

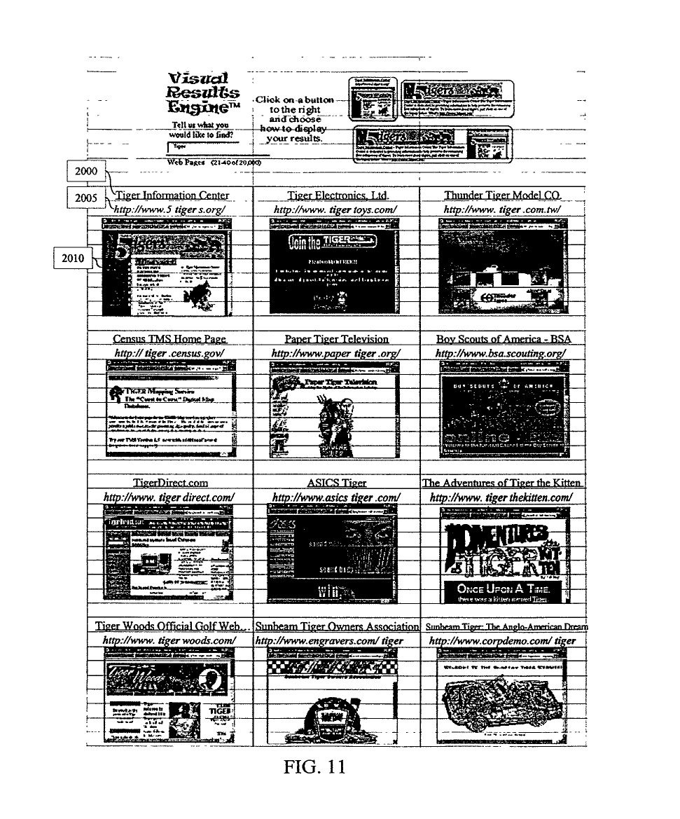

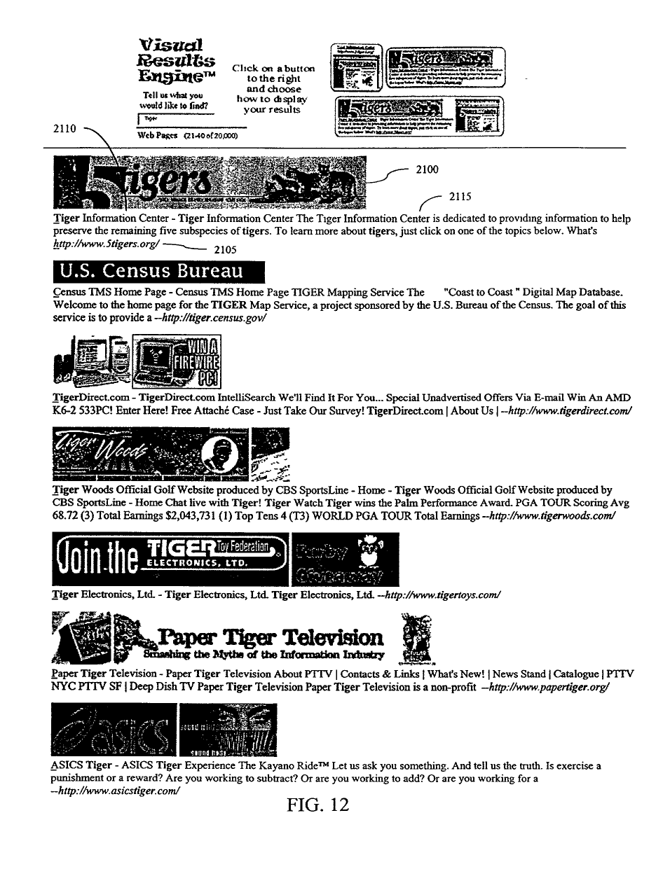

FIG. 9 is sequence diagram of how a visual search Web server uses the database created by an indexer to create a visual search results HTML document. Visual search Web server 1030 sends visual search form 1700 to Web browser 1025. A user of the Web browser enters search keywords into the search form and sends search request 1705 containing the search keywords to the visual search Web server. The visual search Web server parses 1710 the keywords out of the search request and generates database query 1715 from the parsed out keywords. The visual search Web server sends the database query to database server 1050 and the database server finds results 1720 database records containing the keywords contained within the database query. The database server sends the results database records to the visual search Web server. The visual search Web server builds 1725 results HTML document 1730 using the results database records from the database query. A results HTML document is built in the following manner. Each results database record corresponds to an indexed HTML document containing keywords matching the database query. Each results database record contains the URL, textual data about the indexed HTML document, and a snapshot and representative images taken from the indexed HTML document. The snapshot and representative images taken from the indexed HTML document may be placed in the results HTML document. The textual description may be placed in the results HTML document as well. The URL of the indexed document may be used to create a hyperlink in the results HTML document to the indexed HTML document. This hyperlink may be made selectable as either a text string or by selecting an icon created from the indexed HTML document's snapshot or representative images. Displays generated from exemplary results HTML documents are depicted in FIGS. 10 through 12. The visual search Web server sends the results HTML document to the Web browser.

FIG. 10 is an exemplary display created from an exemplary results HTML document. Entry field 1900 displays the keyword that was used to create the database query. A plurality of results HTML document formats are provided. Selecting one of the plurality of buttons 1905 provides one a set of different results layouts. Selection of button 1930 generates the exemplary display. The exemplary display contains images extracted from HTML documents containing the keyword “tiger”. Snapshot 1910 is taken from a top level HTML document located URL 1920 or “www.5tigers.org”. Description 1925 is the text stored as a description and extracted from the top level HTML document located at www.5tigers.org. Representative image 1915 is one of a set of representative images taken from the top level HTML document located at www.5tigers.org.

FIG. 11 is another exemplary display created from an exemplary results HTML document. The top portion of the display is similar to the exemplary display depicted in FIG. 10. Title 2000 of an indexed HTML document is shown above URL 2005 for the indexed document. Snapshot 2010 taken from the indexed document is displayed below the title and URL of the indexed document. Selecting either the title or the snapshot will retrieve the indexed HTML document from the HTML document's server.

FIG. 12 is another exemplary display created from an exemplary results HTML document. The top portion of the display is similar to the exemplary displays depicted in FIGS. 10 and 11. Title 2110 of an indexed HTML document is shown at the front of description 2115 of the indexed HTML document. URL 2105 for the indexed document is placed at the end of the description of the indexed HTML document. Representative image 2100 taken from the indexed document is displayed above the title, description, and URL of the indexed document. Selecting either the title or the representative image will retrieve the indexed HTML document from the HTML document's server.

Although a preferred embodiment of the present invention has been described, it should not be construed to limit the scope of the appended claims. Those skilled in the art will understand that various modifications may be made to the described embodiment. For example, any communications network which is capable of supporting client-server architecture may be used to implement the invention whereas the disclosed embodiments use HTTP on top of a common TCP/IP network.

Moreover, to those skilled in the various arts, the invention itself herein will suggest solutions to other tasks and adaptations for other applications. For example, an exemplary embodiment has been presented for returning visual results. A HTML document may contain references to other types of representative digital media capable of being captured in a database such as audio files, video clips, and animations. These different digital media may also be captured by a search engine for use as a representative sample.

Furthermore, the exemplary embodiment is presented as a two-step process wherein a spider is used to collect preliminary data about a Web page and an indexer is used to collect and store visual information about a Web page. Those skilled in the art will recognize that the indexer need not store the collected visual information but may instead generate HTML documents on request using the collected visual information.

In addition, an exemplary embodiment has been presented for use with HTML documents. Those skilled in the art will recognize that any electronic document composed in any markup language may be indexed for use in a visual search engine. These electronic documents may be displayed on a variety of devices including handheld general purpose computers, personal digital assistants (PDAs), and wireless telephones with access to a digital communications network such as the Internet.

It is therefore desired that the present embodiments be considered in all respects as illustrative and not restrictive, reference being made to the appended claims and the claims' equivalents rather than the foregoing description to indicate the scope of the invention.

What is claimed is:

1. A method for generating a search result document for a document stored on a computer network, comprising:
retrieving the document from a document location on the computer network;
extracting a document keyword from the document;
extracting representative non-textual data from the document;
storing the document location, document keyword, and the representative non-textual data in a results database record;
receiving a search keyword;
retrieving the results database record based on a document query built from the search keyword; and
generating the search result document using the document location and the representative non-textual data extracted from the results database record.

2. The method of claim 1 wherein the document keyword is extracted from a metatag included in the document.

3. The method of claim 1 wherein the non-textual data is graphical data.

4. The method of claim 1 wherein the non-textual data is audio data.

5. The method of claim 1 wherein the non-textual data is video data.

6. The method of claim 1 wherein the result document is written in a document markup language.

7. A method for generating a search engine index entry for a document stored on a computer network, comprising:
retrieving the document from a document location on the computer network;
extracting a document keyword from the document;
extracting representative non-textual data from the document; and
storing the document location, document keyword, and the representative non-textual data in a results database record.

8. The method of claim 7 wherein the document keyword is extracted from a metatag included in the document.

9. The method of claim 7 wherein the non-textual data is graphical data.

10. The method of claim 7 wherein the non-textual data is audio data.

11. The method of claim 7 wherein the non-textual data is video data.

12. The method of claim 7 wherein the result document is written in a document markup language.

13. A method for generating a search result document for a document stored on a computer network, comprising:
receiving a search keyword from a requesting computer system;
retrieving a results database record based on a document query built from the search keyword; and
generating the search result document using a document location and representative non-textual data extracted from the results database record.

14. A method for generating by a search engine a search result markup language document for a markup language document stored on a storage computer accessible via the Internet, comprising:
retrieving from the storage computer via the Internet the markup language document using the markup language document's uniform resource locator;
extracting a document keyword from metatags included in the markup language document;
extracting representative non-textual data using tags included in the markup language document;
storing the markup language document uniform resource locator, document keyword, and the representative non-textual data in a results database record;
receiving a search keyword from a requesting computer via the Internet;
retrieving the results database record based on a query generated from the search keyword;
generating the markup language search result document using the document location and the representative non-textual data extracted from the results database record; and
transmitting the markup language search result document to the requesting computer via the Internet.

15. A data processing system adapted to generate a search result document for a document stored on a computer network, comprising:
a results database;
a processor; and
a memory operably coupled to the processor and having program instructions stored therein, the processor being operable to execute the program instructions, the program instructions including:
retrieving the document from a document location on the computer network;
extracting a document keyword from the document;
extracting representative non-textual data from the document;
storing the document location, document keyword, and the representative non-textual data in a results database record in the results database;
receiving a search keyword;
retrieving the results database record from the results database using a document query built from the search keyword; and
generating the search result document using the document location and the representative non-textual data included in the results database record.

16. The data processing system of claim 16 wherein the document keyword is extracted from a metatag included in the document.

17. The data processing system of claim 16 wherein the non-textual data is graphical data.

18. The data processing system of claim 16 wherein the non-textual data is video data.

19. The data processing system of claim 16 wherein the non-textual data is audio data.

20. The data processing system of claim 16 wherein the result document is written in a document markup language.
